(19) United States
(12) Patent Application Publication
(10) Pub. No.: US 2026/0258901 A1
(43) Pub. Date: Sep. 3, 2026

(54) Flexible and Lockable Joint

(71) Applicant: Adam Czub, Toronto (CA)

(72) Inventor: Adam Czub, Toronto (CA)

(21) Appl. No.: 18/387,308

(22) Filed: Nov. 6, 2023

Related U.S. Application Data
(60) Provisional application No. 63/423,092, filed on Nov. 7, 2022.

(51) Int. Cl. F16M 13/02; F16C 11/06; F16M 11/40

(52) U.S. Cl. CPC F16M 13/022; F16C 11/06; F16M 11/40

(57) ABSTRACT

A flexible joint is disclosed having first and second members coupled by a biasing member. The second member has a concave surface, and the first member has a projecting portion with a distal end configured to abut against the concave surface. The biasing member is positioned within a passageway in the projecting portion, the biasing member having a first end pivotally connected to the first member at a focal point of the concave surface. The second end of the biasing member is anchored to the second member at an anchor point on the concave surface. The biasing member is configured to exert a biasing force sufficient to hold the first and second members in a first position while still permitting the first and second members to be moved relative to each other into a second position by the application of a moving force exceeding a preselected level.

### CROSS REFERENCE TO RELATED APPLICATION

This application claims priority from United States Provisional application no.: U.S. 63/423,092 filed Nov. 7, 2022, the entirety of which is incorporated herein by reference.

### FIELD OF THE INVENTION

The invention relates generally to flexible joints.

### BACKGROUND OF THE INVENTION

Holding objects such as microphones, lights and cameras in position relative to a tabletop, wall, ceiling or floor is usually accomplished by means of a tripod, stand, boom arm or similar device. Such devices are generally fitted with a flexible joint to enable the user to place the object in a plurality of different positions as required. The flexible joint usually has a friction fitting which enables the flexible joint to be bent or angled allowing the object to be position as desired. The friction fitting usually has a screw operated or lever operated locking mechanism permitting the flexible joint to be unlocked to move the object as desired, and then locked into position by engaging the screw or lever. In some cases, the flexible joint consists of a ball joint having an annular member and ball, with the annular member constricted or loosened by means of a screw to lock and unlock the ball joint. While these ball joints are useful and find wide application in tripods, boom arms and other similar devices, they do have disadvantages. These devices generally require the tightening screw or lever to engage with a large force to enable the flexible joints to hold tightly in position. Also, most flexible joint designs are only useful for short connections due to the need to make a strong friction locking mechanism using a screw or lever arm; therefore, their design is not suitable for making long flexible arms, often called goose necks. Also, locking and unlocking the flexible joints require the tedious turning of a screw or lever, making quick repositioning the flexible joint difficult. An improved flexible joint having a simple and flexible design which is suitable for use either alone or in combination with other identical flexible joints to make a goose neck is desirable.

### SUMMARY OF THE INVENTION

In accordance with one aspect of the present invention, there is provided a flexible joint which includes first and second members coupled together by a biasing member. The second member has a concave surface and the first member has a projecting portion with a distal end which is configured to abut against the concave surface. The biasing member is positioned within a passageway in the projecting portion, the biasing member having a first end pivotally connected to the first member at a focal point of the concave surface. The second end of the biasing member is anchored to the second member at an anchor point on the concave surface. The biasing member is configured to exert a biasing force sufficient to hold the first and second members in a first position while still permitting the first and second members to be moved relative to each other into a second position by the application of a moving force exceeding a preselected level.

In accordance with another aspect of the invention, there is provided a flexible joint which includes a plurality of joint members coupled together, each joint member having a female concave surface on one side of the joint member and a corresponding male convex surface on an opposite side of the joint member. Each of the joint members has a passage extending from the convex surface to the concave surface, the passage having a smaller opening on the concave surface and a larger opening on the convex surface, the smaller opening positioned at a focal point of the concave surface. There is also included a flexible tendon positioned through the passages of the plurality of joint members with the joint members aligned in a series of adjacent joint members such that the male convex surfaces of the joint members mate with the female concave surfaces of the adjoining joint members. The flexible tendon is adapted and configured to apply a biasing force to the joint members to hold the joint members firmly together in series.

In accordance with yet another aspect of the present invention, there is provided a flexible joint which includes first and second members having abutting concentric convex and concave surfaces, respectively, the first and second members being coupled together by a biasing member having opposite first and second ends. The first end of the biasing member is pivotally attached to the first member at a focal point of both concave and convex surfaces, while the second end is anchored to the second member at an anchor point on the concave surface. The biasing member is positioned in a passage in the first member and the biasing member extends between the focal point and an opening on the convex surface. The opening is dimensioned to permit the biasing member to move radially within the passage to permit the first and second members to move relative to each other. The biasing member is configured to exert a consistent biasing force sufficient to hold the first and second members firmly together as the first and second members are moved relative to each other.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a cross sectional view of a flexible joint made in accordance with the present invention showing the first end of the tendon portion anchored to the concave member, with the concave and convex members being held out of coaxial alignment.

FIG. 2. is a cross sectional view of an alternate embodiment of a flexible joint made in accordance with the present invention showing the first end of the tendon anchored to the convex member with the convex and concave member being held in coaxial alignment.

FIG. 3 is a cross sectional view of the convex member shown in FIG. 1.

FIG. 4A is a cross sectional view of an alternate embodiment of the flexible joint made in accordance with the present invention showing the first and second members in coaxial alignment.

FIG. 4B is a cross section view of an alternate embodiment of the flexible joint made in accordance with the present invention showing the first and second members positioned out of coaxial alignment.

FIG. 5 is a goose neck flexible joint made in accordance with the present invention.

FIG. 6 is a cross sectional view of an alternate embodiment of the flexible joint made in accordance with the present invention having multiple members of different sizes arranged to form a goose neck.

FIG. 7 is a cross sectional view of a flexible ball joint made in accordance with the present invention showing how forces are applied in the joint through the tendon cable.

FIG. 8 is a cross sectional view of a flexible ball joint where a radial center of the flexible ball joint is behind the center of the tendon cable.

FIG. 9 is a cross sectional view of a flexible ball joint where the radial center of the flexible ball joint is in front of the center of the tendon cable.

FIG. 10A is a side view of goose neck structures incorporating the flexible joint made in accordance with the present invention.

FIG. 10B is a side view of a goose neck structure incorporating the flexible joint made in accordance with the present invention.

FIGS. 10C to 10E are side views of support structures incorporating the flexible joint made in accordance with the present invention.

FIGS. 10F to 10I are side views of alternate support structures incorporating the flexible joint made in accordance with the present invention.

FIG. 11 is a cross sectional view of a flexible joint made in accordance with the present invention which incorporates a tensioning element for applying a varying biasing force to said flexible joint.

FIG. 12 is a cross sectional view of an assembly station incorporating the flexible joint made in accordance with the present invention.

FIG. 13 is a top view of a geodesic dome structure incorporating a plurality of flexible joints made in accordance with the present invention.

FIG. 14 shows a boom arm for use in construction of the geodesic dome shown in FIG. 13 being moved from a folded orientation towards a fully arched orientation.

FIG. 15A is a perspective view showing alternate embodiment of the present invention having conical surfaces.

FIG. 15B is a perspective view shown in FIG. 15A without the concave member.

FIG. 15C is a long sectional view of the embodiment shown in FIG. 15A.

FIG. 15D is a perspective view of an alternate embodiment of the present invention having semi-cylindrical surfaces.

FIG. 15E is a perspective view of an alternate embodiment shown in FIG. 15D without the concave surface.

FIG. 15F is a long sectional view of the alternate embodiment shown in FIG. 15D.

FIGS. 16A and 16B are cross sectional views of an alternate embodiment of the present invention having an elliptical surface.

FIG. 17 is a long sectional view of an alternate embodiment of a flexible joint made in accordance with the present invention.

FIG. 18 is a long sectional view of yet another alternate embodiment of a flexible joint made in accordance with the present invention.

FIG. 19A is a front view of the protruding portion of the alternate embodiment shown in FIG. 18.

FIG. 19B is a perspective view of the protruding portion of the alternate embodiment shown in FIG. 19A.

In the drawings like characters of reference indicate corresponding parts in the different figures.

### DETAILED DESCRIPTION OF THE INVENTION

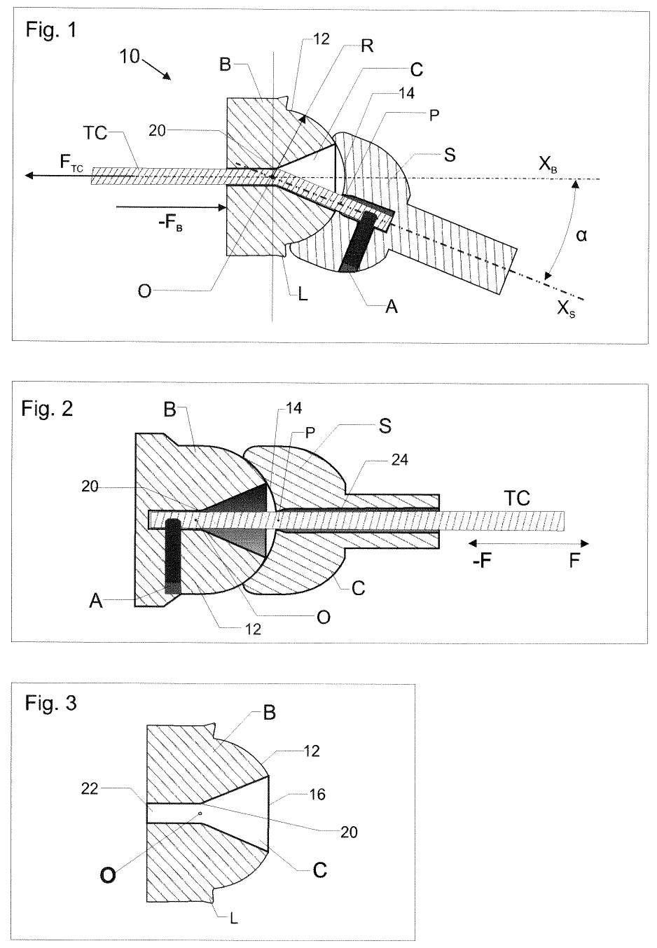

Referring firstly to FIG. 1, a flexible locking joint made in accordance with the present invention is shown generally as item 10, and includes a first member (hereafter called a ball assembly) B and a second member (socket assembly) S. A convex surface 12 is formed on ball assembly B having radius R and a concave surface 14 is formed on socket assembly S, the concave surface also having a radius of R. Ball assembly B and socket assembly S are dimensioned and configured such that concave and convex surfaces are concentric and can abut while the two members (assemblies) can move relative to each other between a first position wherein the two members are in coaxial alignment as shown in FIG. 2 to a plurality of different positions wherein the two members are not coaxially aligned (see FIG. 1). Concave surface 14 and convex surface 12 are formed to closely match each other such that they form a mated male and female pair of surfaces sharing the same radial center point O. Members B and S can move relative to each other by an angle α between axis X_{B} and X_{S}. Lip L is provided on member B to limit the angular movement of member S. Point O is essentially a focus point (radial center point) of concave surface 14 and convex surface 12.

A biasing member in the form of tendon cable TC passes through passage C and through radial center point O and through center point P being the center of the concave surface 14. Point P forms an anchor point which restricts the position where tendon cable TC contacts concave surface 14. Tendon cable TC is flexible and preferably it is also highly resistant to stretching. Positioning tendon cable TC to pass directly through both points O and P ensures that the length of cable TC remains constant regardless of whether joint 10 is orient in a coaxial position (see FIG. 2) or at a non-coaxial position (see FIG. 1). Since the length of cable TC between points O and P remains constant, applying biasing force F_{TC} through cable TC urges (biases) members B and S towards each other without causing the relative position between the two members to change. If biasing force F_{TC} is sufficiently high, members B and S are forced together such that the frictional forces between surfaces 12 and 14 are strong enough to keep the members locked together even if external forces are applied against the joint in an attempt to move members B and S out of position. Cable TC is restricted in how it can move by the shape of passage C and by the position of points O and P. In the embodiment shown, biasing member (cable) TC is restricted to moving radially within chamber C around point O. The biasing force FTC applied by biasing member TC remains consistent as the biasing member is moved radially within chamber C. Moving members B and S out of position would require the application of an external moving force sufficient to exceed the effect of the biasing force. Therefore, increasing or decreasing the biasing force FTC results in a corresponding change to the force required to move members B and S so as to reposition the members relative to each other. In turn, this means that manipulating or selecting the biasing force FTC can be used to selectively lock and unlock members B and S in a plurality of different positional orientations while allowing the members to be shifted from one positional orientation to another without having to resort to high moving forces. Biasing force FTC can be selectively lowered before members B and S are repositioned than selectively increased to lock the members in the new positional orientation.

One end of cable TC can be rigidly mounted to one of the members while the other end can be positioned away from joint 10 such that biasing force F_{TC} can be selectively varied to control the strength of the frictional forces locking members B and S in place. In the embodiment shown in FIG. 1, one end of cable TC is mounted to member S by a screw A while the opposite end of cable TC projects out the back side of member B. In the alternate embodiment shown in FIG. 2, the one end of cable TC is mounted to member B by a screw A′ while the opposite end of cable TC projects out of member S. The portion of cable TC which extends between points O and P is positioned within channel C, which is dimensioned to permit cable TC to move freely between axis X_{B} and X_{S}. As best seen in FIG. 3, channel C is tapered and widens as it extends from point O to opening 16 on surface 12. The dimensions of opening 16 are constrained by the width of the concave surface which is to be placed onto convex surface 12. Point 20 of channel C is important as it corresponds to point O, which as point out above, is the center of the convex surface 12. Passage 22 couples to channel C and permits the cable TC (see FIGS. 1 and 2) to either pass through the back of member B or to be locked to member B. The narrowest end of channel C starts at point 20 which is at point O. As seen in FIGS. 1 and 2, cable TC must pass point O and point 20 ensures that the cable remains properly oriented such that the length of cable TC between points O and P remains constant.

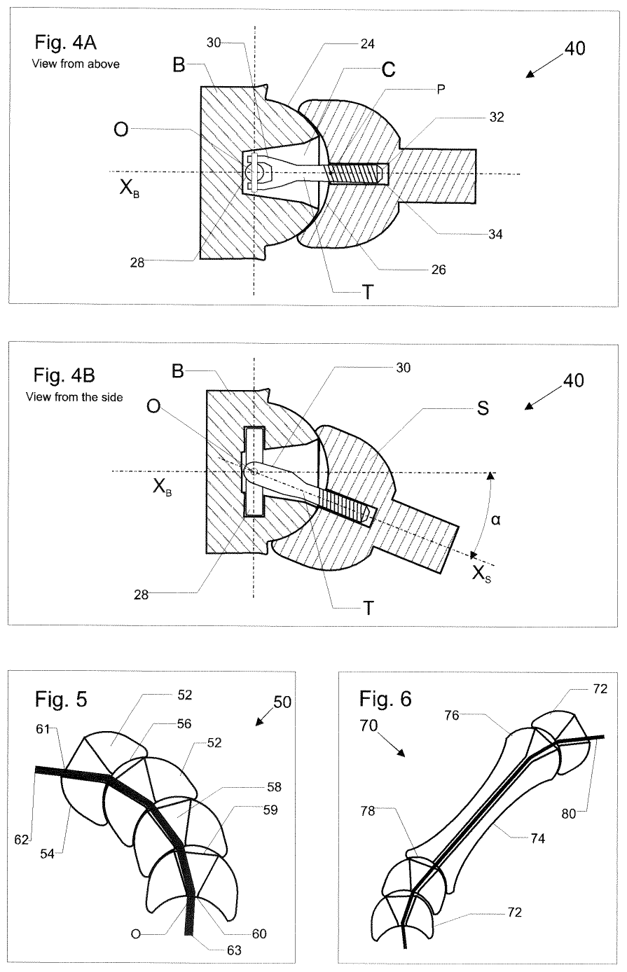

Referring now to FIGS. 4a and 4b, another embodiment 40 of the present is illustrated which includes a tightening element which is configured to selectively apply tension to the biasing member. As seen in FIGS. 4a and 4b, members B and C are coupled together by a rigid biasing member T which is flexibly mounted at the center point O of convex surfaces 24 and concave surfaces 26. End 30 of rigid member T can form a part of a U-type joint 28 positioned at point O of member B and end 32 of rigid member T can be threaded to thread onto threaded passage 34 formed at the center P of the concave surface 26. By rotating member S along axis X_{S} with respect to member B, rigid member T can apply a variable biasing force onto members B and S. The threaded portions of members T and S form a tightening element which can selectively apply a greater or lesser tension force to the biasing member T and therefore vary the biasing force applied by the biasing member to members S and B. The biasing force applied to the two members can be increased or decreased by either tightening or loosening member S. Hence, the joint can loosed to permit members B and C to be placed at angle α to each other (FIG. 4b) and then tightened such that the members remain in position even if force is applied to the joint to try to move the members out of position. If a large external force is to be applied to the joint, then the members can be screwed more tightly together to lock the joint more firmly in position. If the joint is to be repositioned slightly, then the members can be loosened slightly to permit the members to be moved slightly into the desired orientation and then tightened firmly by screwing member S.

The joint of the present invention can be used to form a flexible goose neck structure where the goose neck consists of a plurality of members strung together by a tension cable or tendon passing through each of the members. Such an embodiment is shown in FIG. 5 as item 50 and consists of a plurality of members 52, each member having a convex surface 54 and a concave surface 56. The members 52 are aligned together in series such that the convex surface of one member is received in the concave surface of the adjacent member. A flared passage 58 is formed on each member extending between a narrow opening 60 on the concave surface 56 and a larger opening 59 on the convex surface 54. A cable or tendon 61 is strung through each of the members such that the members are strung together in series between ends 62 and 63 of cable 61. For each individual member 52, opening 60 is positioned at the radial center of convex surface 54 and the geometric center of concave surface 56 for that individual member. It will be appreciated that the radial center of concave surface 56 for any single member 52 is also the radial center of surface 54 of the adjacent member. As in the previous embodiments, the section of cable 61 passing between opening 60 and opening 59 remains constant regardless of the orientation between the members; therefore, the biasing force applied to cable 61 when the ends of the cable are mounted to the members forming the opposite ends of the series of members 52 will remain constant regardless of the orientation the members are in. Hence, if the series of members 52 are placed into a straight coaxial orientation, then a strong biasing force applied to the members by cable 61 will lock the members in said straight coaxial orientation. On the other hand, if the members are placed into a curved or sinusoidal orientation, then applying a strong biasing force to the members through cable 61 will lock the members in the selected curved or sinusoidal orientation. This allows for the construction of a flexible goose neck structure which can be loosened to place the goose neck into a specific orientation by gently manipulating the members into the desired orientation before then locking the goose neck in the desired orientation by applying a strong biasing force to the goose neck via cable 61.

FIG. 6 illustrates an alternate goose neck structure 70 formed from a plurality of members 72 and a single elongated member 74. Members 72 are identical to members 52 in the previous embodiment (see FIG. 5) and each have concave and convex surfaces. Elongated member 74 has a convex surface 76 at one end and a concave surface 78 at it's opposite end. Convex surface 76 and concave surface 78 are substantially identical to the convex and concave surfaces, respectively, of members 72. A single cable/tendon 80 passes through each of the members. As in the previous embodiment, the goose neck can be placed into a locked state by applying a sufficiently large biassing force onto cable/tendon 80, and also as in the previous embodiment, it can be placed into a more easily pliable state by lowering the biasing force of the cable/tendon.

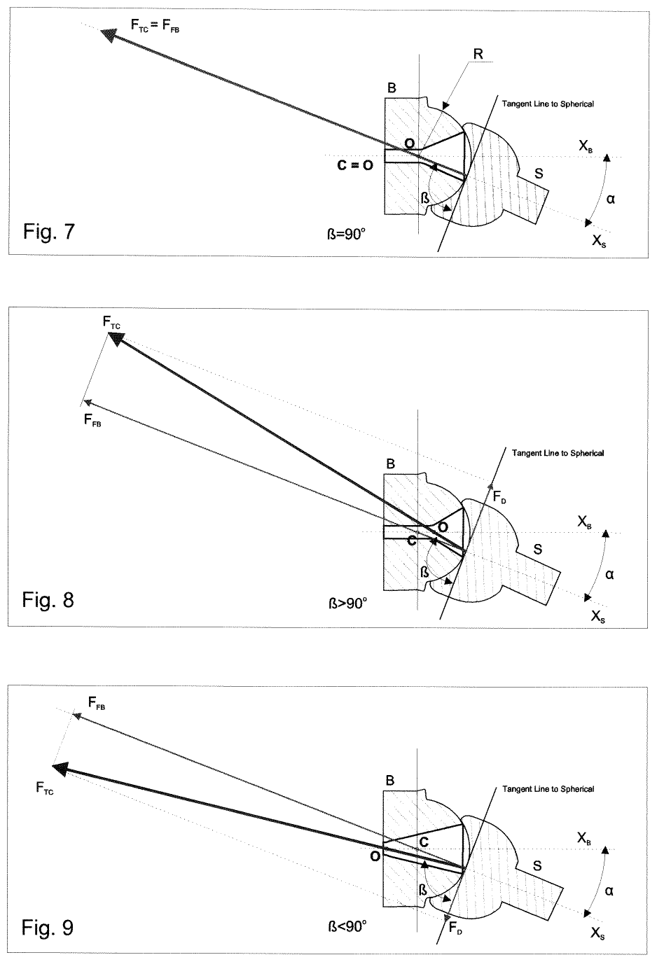

Referring now to FIGS. 7, 8 and 9, the positioning of point O is critically important to the functioning of the present invention. Point O must be at the radial center of the convex and concave surfaces. When the tendon/cable is constrained to pass through point O and point O is also the radial center of the convex and concave surfaces, then applying a biasing force to the two members will force the two members together without causing the members to move relative to each other. Essentially, when the tendon/cable passes through point O, the biasing force applied to the two members will not have any transverse moment. In FIG. 7, point O is set at C, the radial center of the concave and convex surfaces. When the biasing force (F_{TC}) is applied to members B and S by the cable/tendon, then F_{TC} is equal to the frictional binding force F_{FB} which holds members B and S together. In this scenario, F_{TC} and F_{FB} are coaxially aligned and there is no moment of force attempting to move one member relative to the other member. F_{TC} is perpendicular to the tangent line of the convex and concave surfaces, i.e. β=90°. In FIG. 8, point O is moved forward of point C, which has the effect of placing F_{TC} at an angle to F_{FB}, thereby creating a resulting force F_{D} which acts to deflect the members out of their desired orientation causing locking to be unsuccessful. In this scenario β>90°. In FIG. 9, point O is placed behind point C, again placing F_{TC} at an angle from F_{FB} creating a resulting force F_{D} which acts to deflect the members out of their desired orientation; β<90°. If in scenario visualized in FIGS. 8 and 9 the deflecting component of the force was to succeed in shifting position of the members, the geometry of the joint would in both scenarios cause the tendon to slacken. As tendons succumb to stretching when engaged, small discrepancies in manufacturing providing only approximate concentricity of the points O and C within certain margins, might still yield somewhat reliable locking condition as the range of the slacking of the tendon would be within the range of tendon's working length flexibility, however if combined with external work load co-linear with the direction of the force of the deflection, such condition might lead to adverse sudden loss of all carrying capacity of a previously seemingly properly locked joint. The present invention places point O exactly at the radial center (C) of the convex and concave surfaces to ensure that F_{TC} is coaxial aligned with F_{FB} so that F_{D} is zero and the convex and concave members remain in their original orientation when the biasing force applied by the tendon/cable (F_{TC}) is increased, and there is a geometrical certainty the tendon's working length remains constant at all working alignments of the joint.

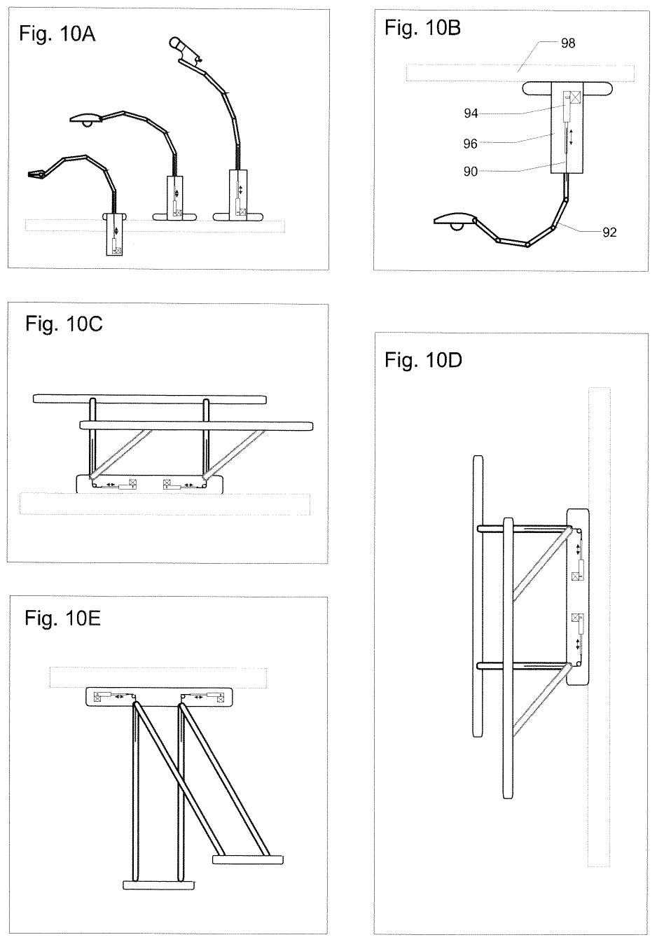

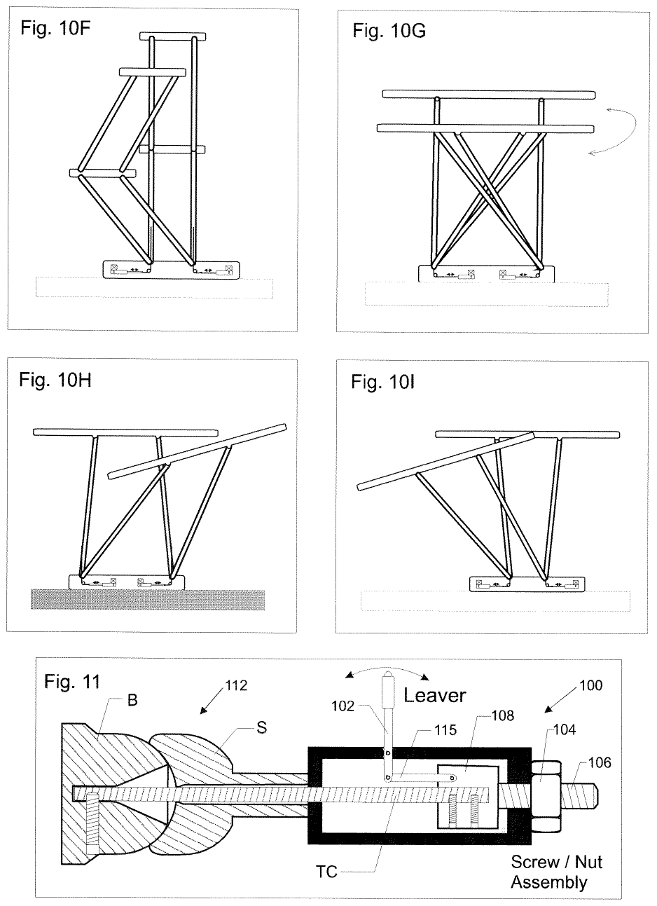

Referring now to FIGS. 10a to 10b, the present invention can be incorporated into a variety of different goose neck structures such as microphone stands, lamp stands, clamp stands, or the like. As shown in FIG. 10b, each stand or support has a tendon/cable 90 coupled between the gooseneck 92 and a tensioning element 94 located in a housing 96. Housing 96 can be mounted to a wall, table, or ceiling 98 (or any other structure) by means known generally in the art. The tensioning element 94 is configured to apply a biasing force on tendon/cable 90 to keep the goose neck locked in position in order to support the object supported by the goose neck. It will be appreciated that the tensioning element can take the form of a spring or other similar structure to keep tendon/cable 90 under constant tension thereby applying constant biasing force to the joint elements forming the goose neck. Alternatively, tensioning element can consist some sort of lever or screw configured to adjust the tension on the cable/tendon as required.

FIGS. 10c to 10i show a plurality of different applications for the flexible joint made in accordance with the present invention. These applications can use the flexible joint in the construction of reconfigurable tables, shelving and even adjustable wall mounts for TVs.

FIG. 11 illustrates how a tensioning element 100 can be constructed to selectively adjust the biasing force applied to cable TC for locking and loosening flexible joint 112 which is made in accordance with the present invention. The tensioning element will generally consist of a housing enclosing one end of cable/tendon TC. A screw member 106 and nut member 104 can be provided to permit the user to increase or reduce the tension on cable/tendon TC by turning nut 104. Lever arm 102 can also be provided to allow the user to apply additional tension or relief to cable TC by means of cable anchor 108 coupled to lever arm 102 by a link arm.

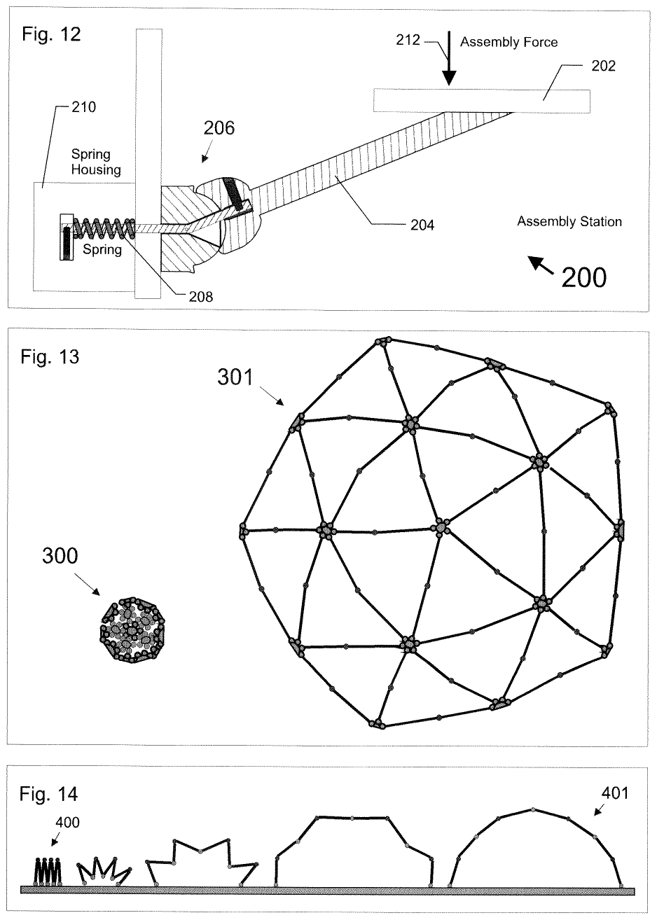

Referring now to FIG. 12, an assembly station or table, shown generally as item 200, can be constructed using a flexible joint made in accordance with the present invention. A table surface (or assembly surface) 202 can be held in position at the end of boom arm 204 by means of flexible joint 206. The amount of assembly force 212 which can be applied to the table surface 202 before the table surface moves is governed by the biasing force applied by biasing spring 208 in spring housing 210 to joint 206. The required assembly force 212 can be selected by selecting the strength of spring 208.

Referring now to FIGS. 13 and 14, a geodesic dome structure can be constructed from a plurality of elongated arms joined together by flexible joints made in accordance with the present invention. Individual boom arms, as illustrated in FIG. 14, can be folded up tight for storage and then expanded by moving the individual boom arms relative to each other and then locking the arms into position. The flexible joints linking the individual boom arms can be selectively loosened or tightened as required to permit the dome structure to be quickly unfolded and placed in the correct orientation, at which point the flexible joints can be tightened to keep the dome structure in the correct shape.

The calculation of the biasing force required to “lock” the flexible joint in position for a flexible joint made in accordance with the present invention shall now be discussed. The working parameters of the joint can be calculated using conventional geometry and standard force distribution analysis, taking under consideration the coefficient of friction between the joint parts surfaces.

The simplest approach would be based on the proportional leverage about the common fulcrum point calculation, where the short part of the arm would be the circumference of the ball (convex surface) against which the force of friction would lock the socket assembly (concave surface). The other—the long—arm would be the working length of the arm affixed to socket assembly with the force applied perpendicularly to the socket axis. The lengths of arms would be measured with respect to the common fulcrum point—in this case center of the circumference of the ball (convex surface).

As the coefficient of friction of the material of choice (in the case of the prototype: aluminum) can be for simplicity sake assumed to be 1 (actual with clean and dry conditions—1.05-1.35, and 0.3 when greased), the force of friction in ideal conditions would be roughly equal to the force applied along the tension tendon within the joint. The resulting force sustainable at the end of the working arm would be proportional to the Ball radius R and the force of Tension/Friction FT and inversely proportional to length of such arm L. It is expected to have the need to adjust the ball diameter to the working diameter of the tendon—in most cases standard steel cable—to allow for the appropriate channel to be bored in the joint assembly taking under consideration the bending radius of the tendon.

The formula for the calculation would look like this:

$$FW = FT \times R / L$$

### Example Calculation A

R—Radius of the Ball—20 mm
L—Length of the arm—1 m (1000 mm)

$$FT - Force of Tension / Friction - 5000 N ( roughly equivalent to 1 / 2 T ) over 1 / {4}^{″} steel cable$$

FW—Force of available working range before the arm holding capacity is exceeded:

$$FW = 5000 N \times 20 mm / 1000 mm = 100 N$$

In laymen terms: if the radius of the ball socket joint is 20 mm and the tension applied is roughly ½T, with the coefficient of friction of aluminum over aluminum roughly equal to 1, the working conditions at 1 m arm would be up to estimated 10 KG. The tension capacity for a standard ¼″ steel cable fits this example.

### Example B

With R=30 mm, FT=1T over ⅜″ cable and L=1 m, the work force limit would be FW=30 KG

### Example C

With R=50 mm, FT=7T over 1″ cable and L=1 m, the work force limit would be FW=350 KG

All of the above examples using copper over copper in dry and clean conditions with coefficient of friction 1.6 would yield respectively A:16 KG, B:48 KG and C:560 KG

In all of the above calculations, safe 5 to 1 tolerance values for breaking strength to safe working load of steel cables has been used. If 2 to 1 ratio would be assumed as the safe static support load constraint for entire assembly of the joint and the arm, the above examples utilizing aluminum components would have safe working loads (with arm perpendicular to the load) of A:5 KG, B:15 KG and C:175 KG, and with copper A:8 KG, B:24 KG and C:280 KG

It is worth noting the above force values for tension over tendon can easily be supplied with standard of the shelf screw/nut assemblies. With Industrial size of components, applications for loads of far greater values can easily be conceived of.

Preliminary experimental measurements taken with a setup composed of a ball of R=7.5 mm, FT=80 KG and the arm L=920 mm sustained maximum perpendicular to the end of the arm forces of approximately 200 g, which would indicate the coefficient of friction of approximately 0.3. The components were manufactured using standard turning methods accessible at hobbyist's workshop, after which components have undergone rudimentary cleaning with acetone, which with an uneven finish doesn't provide full de-greasing. This measurements conform to the least favorable conditions for this application—namely coefficient of friction of 0.3 indicated for aluminum over aluminum when greased.

Assuming greased conditions, the example calculations given at the top would yield lower values than if under clean and dry conditions. Still under 2 to 1 safety margin of load stressing, those would respectively be: A:1.5 KG, B:5 KG and C:55 KG.

This test shows adherence to the theory of calculation well within the order of magnitude from the projected values and full conformity of the calculations to the gathered data, and currently available friction coefficients. This allows for predictable extrapolation as to loads that could be achieved given higher quality of manufacturing and more stringent, uniform and consistent working conditions.

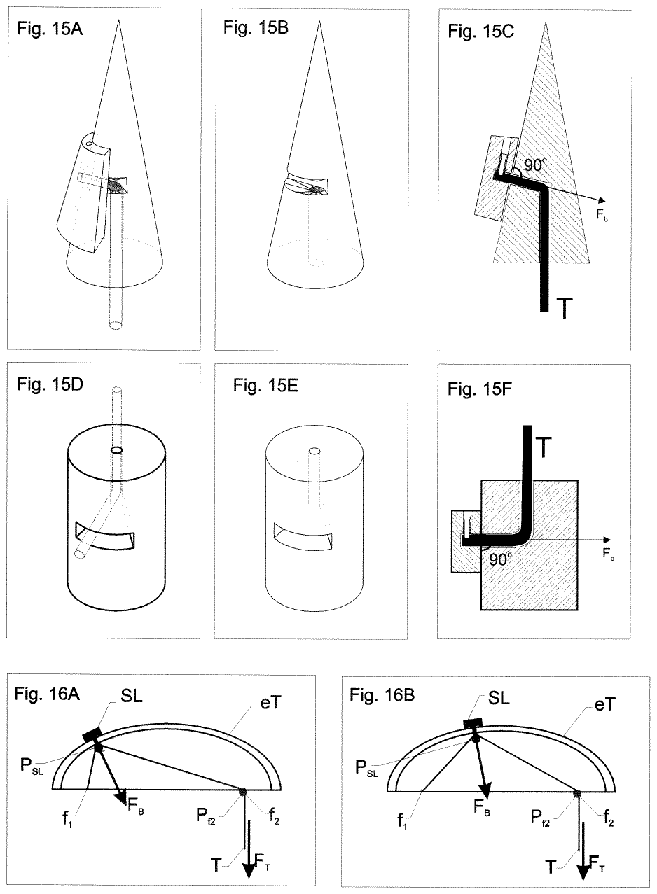

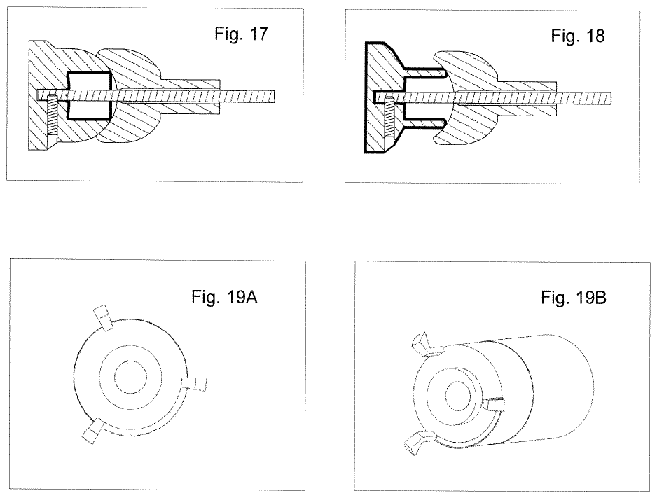

Many different embodiments of the present invention are possible. For example, FIGS. 1 through 9 of the present application illustrated a flexible joint made in accordance with the present invention which used semi-spherical convex and concave surfaces (i.e. ball and socket members/portions). However, the present invention also includes embodiments which use concave and convex surfaces which are cylindrical, conical or circular in nature as illustrated in FIGS. 15a through 15f. A key feature of the present invention is the use of a concave surface on one member which is in abutting contact with a projecting portion of another member. In the embodiments illustrated in FIGS. 1 through 15f, the portions in abutting contact of the two members share a common radial surface, regardless of the surfaces being semi-spherical, semi-cylindrical or semi-conical. The invention also extends to embodiments having only one concave surface on one member and a projecting portion on the other member which is not necessarily a convex surface but is configured to bear against the concave surface as illustrated in FIG. 18. Mating concave and convex surfaces will have the advantage in maximizing the surface area of contact between the two members, but there are applications where a minimal surface area of contact may be advantageous. FIG. 19a presents a frontal ortographic drawing of such a solution and FIG. 19b shows a 3d drawing of same. Furthermore, in the embodiments discussed so far, the passage within which the biasing member is retained is illustrated as having a flaring profile which widens from the focal point towards the concave surface. FIG. 17 illustrates an embodiment of the present invention where the passageway is made more or less cylindrical, which could decrease the cost and simplify the construction of the flexible joint. Such approach was used when constructing a first prototype.

As shown in FIGS. 16a and 16b it could also be conserved a version of the joint conforming to elliptical geometry. In such scenario a tendon T needs to be fixed in a focal point f1 and then run through a pulley mounted to a slider SL that replaces the concave member of the assembly and then through yet another pulley located at the focal point f2. The elliptical track eT replacing the ball assembly forms the base on which the slider SL travels. When a force of tension FT is applied to the tendon T the distribution of forces along the length of the tendon according to commonly understood aspects of elliptical geometry will yield a resultant force of binding Fb that is at 90 deg to the tangent line to the ellipse at the point of resting of the slider SL. FIGS. 16a and 16b show two different positions of the sliders with an indication how that condition is met. According to the ellipse geometry such design would also yield a constant tendon length throughout the entirety of the range of motion of the slider on the surface of the eliptical track eT.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A flexible joint comprising first and second members having abutting concentric convex and concave surfaces, respectively, the first and second members being coupled together by a biasing member having opposite first and second ends, the first end being pivotally attached to the first member at a focal point of both concave and convex surfaces, the second end being anchored to the second member at an anchor point on the concave surface, the biasing member being positioned in a passage in the first member extending between the focal point and an opening on the convex surface, the opening being dimensioned to permit the biasing member to move radially within the passage to permit the first and second members to move relative to each other, the biasing member configured to exert a consistant biasing force sufficient to hold the first and second members firmly together as the first and second members are moved relative to each other.

2. The joint defined in claim 1 further comprising a tightening element coupled to the biasing member, the tightening element configured to apply tension to the biasing member to create the biasing force.

3. The joint defined in claim 2 wherein the tightening element is further configured to selectively apply the tension to the biasing member to change the biasing force as desired.

4. The joint defined in claim 3 wherein the tightening element comprises a screw coupled to the biasing member and a nut threaded onto the screw, the nut and screw being configured such that selectively turning the nut relative to the screw causes a corresponding change in the tension applied to the biasing member.

5. The joint defined in claim 3 wherein the tightening element comprises a lever movable between first and second positions wherein the lever applies greater or lesser tension to the biasing member, respectively.

6. The joint defined in claim 1 wherein the passage has a diameter which increases from the focal point to the opening.

7. A flexible joint comprising a plurality of joint members coupled together, each joint member having a female concave surface on one side of the joint member and a corresponding male convex surface on an opposite side of the joint member, each joint member having a passage extending from the convex surface to the concave surface, the passage having a smaller opening on the concave surface and a larger opening on the convex surface, the smaller opening positioned at a focal point of the concave surface, a flexible tendon passing through the passages of the plurality of joint members with the joint members aligned in series of adjacent joint members such that the male convex surfaces of the joint members mate with the female concave surfaces of the adjoining joint members, the flexible tendon adapted and configured to apply a biasing force to the joint members to hold the joint members firmly together in series.

8. The joint defined in claim 7 further comprising a tightening element coupled to the flexible tendon, the tightening element configured to apply tension to the flexible tender to create the biasing force.

9. The joint defined in claim 8 wherein the tightening element is further configured to selectively apply the tension to the biasing member to change the biasing force as desired.

10. The joint defined in claim 9 wherein the tightening element comprises a screw coupled to the flexible tendon and a nut threaded onto the screw, the nut and screw being configured such that selectively turning the nut relative to the screw causes a corresponding change in the tension applied to the flexible tendon.

11. The joint defined in claim 10 wherein the tightening element comprises a lever movable between first and second positions wherein the lever applies greater or lesser tension to the flexible tendon, respectively.

12. The joint defined in claim 7 further comprising a spring coupled to the flexible tendon, the spring applying tension to the flexible tendon to generate the biasing force.

13. A flexible joint comprising first and second members coupled together by a biasing member, the second member having a concave surface and the first member having a projecting portion with a distal end configured to abut against the concave surface, the biasing member positioned within a passageway in the projecting portion, the biasing member having a first end pivotally connected to the first member at a focal point of the concave surface, the second end being anchored to the second member at an anchor point on the concave surface, the biasing member is configured to exert a biasing force sufficient to hold the first and second members in a first position while still permitting the first and second members to be moved relative to each other into a second position by the application of a moving force exceeding the biasing force.

14. The joint defined in claim 13 further comprising a tightening element coupled to the biasing member, the tightening element configured to apply tension to the biasing member to create the biasing force.

15. The joint defined in claim 14 wherein the tightening element is further configured to selectively apply the tension to the biasing member to change the biasing force as desired.

16. The joint defined in claim 15 wherein the tightening element comprises a screw coupled to the biasing member and a nut threaded onto the screw, the nut and screw being configured such that selectively turning the nut relative to the screw causes a corresponding change in the tension applied to the biasing member.

17. The joint defined in claim 15 wherein the tightening element comprises a lever movable between first and second positions wherein the lever applies greater or lesser tension to the biasing member, respectively.

18. The joint defined in claim 13 wherein the passage has a diameter which increases from the focal point to the opening.

19. The joint defined in claim 13 wherein the distal end of the first member is formed as a convex surface, the concave and convex surfaces having mating semicircular profiles, the focal point lying on an axis of rotation of the mating semicircular profiles, the passage being dimensioned and configured to permit the biasing member to move radially relative to the focal point and permit the second member to move relative to the first member.

20. The joint defined in claim 19 further comprising a tightening element coupled to the biasing member, the tightening element configured to selectively apply tension to the biasing member to selectively change the biasing force applied by the biasing member, the biasing member and tensioning element being configured such that the biasing force applied by the biasing member remains constant as the second member is moved relative to the first member.
